(19) United States
(12) Patent Application Publication
(10) Pub. No.: US 2020/0277926 A1
(43) Pub. Date: Sep. 3, 2020

(54) CAMSHAFT PHASER INCLUDING A HEAT-TREATED TARGET WHEEL

(71) Applicant: Schaeffler Technologies AG & Co. KG, Herzogenaurach (DE)

(72) Inventor: Alexandre Camilo, Rochester Hills, MI (US)

(73) Assignee: Schaeffler Technologies AG & Co. KG, Herzogenaurach (DE)

(21) Appl. No.: 16/288,177

(22) Filed: Feb. 28, 2019

(51) Int. Cl. F02P 5/02; C21D 9/46; F02D 41/34

(52) U.S. Cl. CPC F02P 5/02; C21D 9/46; F01L 2103/00; F01L 2800/14; F02D 41/34

(57) ABSTRACT

A target wheel for a camshaft phaser, including: a radially disposed wall facing in a first axial direction; a first circumferentially disposed wall connected to the radially disposed wall; a second circumferentially disposed wall connected to the radially disposed wall; and a first tab directly connected to the first circumferentially disposed wall and the second circumferentially disposed wall, extending radially outward past the first circumferentially disposed wall and the second circumferentially disposed wall, and including a heat-treated portion.

### TECHNICAL FIELD

The present disclosure relates to a position sensor target wheel for a camshaft phaser with a heat-treated tab to protect the tab from damage during assembly of the camshaft phaser and a camshaft phaser including the position sensor target wheel with the heat-treated tab.

### BACKGROUND

A known camshaft phaser includes a target wheel engaged with a rotor of the camshaft phaser. A sensor is used to detect a rotational position of the target wheel to enable proper phasing of a camshaft connected to the rotor. During installation of the target wheel in the camshaft phaser, during installation of the camshaft phaser in an engine, and/or due to rough handling of the camshaft phaser prior to installation in the engine, tabs of the position sensor target wheel contact the rotor, and plastic deformation of the tabs can occur. The plastic deformation results in mis-alignment of the target wheel with respect to the rotor and the camshaft. The mis-alignment impairs the ability of a sensor of the engine to properly read the rotor and camshaft positions, causing errors in the timing of the camshaft. Plastic deformation of the tabs also can lead to premature failure of the target wheel.

### SUMMARY

According to aspects illustrated herein, there is provided a target wheel for a camshaft phaser, including: a radially disposed wall facing in a first axial direction; a first circumferentially disposed wall connected to the radially disposed wall; a second circumferentially disposed wall connected to the radially disposed wall; and a first tab directly connected to the first circumferentially disposed wall and the second circumferentially disposed wall, extending radially outward past the first circumferentially disposed wall and the second circumferentially disposed wall, and including a heat-treated portion.

According to aspects illustrated herein, there is provided a camshaft phaser, including: a stator arranged to receive rotational torque and including a plurality of radially inwardly extending protrusions; a rotor including a plurality of radially outwardly extending protrusions circumferentially interleaved with the plurality of radially inwardly extending protrusions and an indentation bounded by a wall; a plurality of phaser chambers, each phaser chamber circumferentially bounded by a respective radially inwardly extending protrusion included in the plurality of radially inwardly extending protrusions and a respective radially outwardly extending protrusion included in the plurality of radially outwardly extending protrusions; a target wheel including a tab with a heat-treated portion; and a bias spring urging the target wheel in a first circumferential direction and the heat-treated portion into contact with the wall of the rotor. A sensor is arranged to detect a rotational position of the target wheel for use in rotating the rotor, with respect to the stator, to change a phase of a camshaft connected to the rotor.

According to aspects illustrated herein, there is provided a method of fabricating a target wheel for a camshaft phaser, including: forming the target wheel to include a radially disposed wall facing in an axial direction, a first circumferentially disposed wall connected to the radially disposed wall, a second circumferentially disposed wall connected to the radially disposed wall, and a tab arranged to engage a rotor for a camshaft phaser, directly connected to the first circumferentially disposed wall and the second circumferentially disposed wall, and extending radially outward past the first circumferentially disposed wall and the second circumferentially disposed wall; and heat-treating a portion of the tab.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a front isometric view of a target wheel, for a phaser, including a heat-treated tab;

FIG. 2 is a back isometric view of the target wheel shown in FIG. 1;

FIG. 3 is a detail of area 3 in FIG. 1;

FIG. 4 is a cross-sectional view generally along line 4-4 in FIG. 3.

FIG. 5 is back isometric view of a camshaft phaser including the target wheel shown in FIG. 1;

FIG. 6 is a section line generally along line 6-6 in FIG. 5;

FIG. 7 is a detail of area 7 in FIG. 6; and

FIG. 8 is a schematic block diagram including the camshaft phaser shown in FIG. 5.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

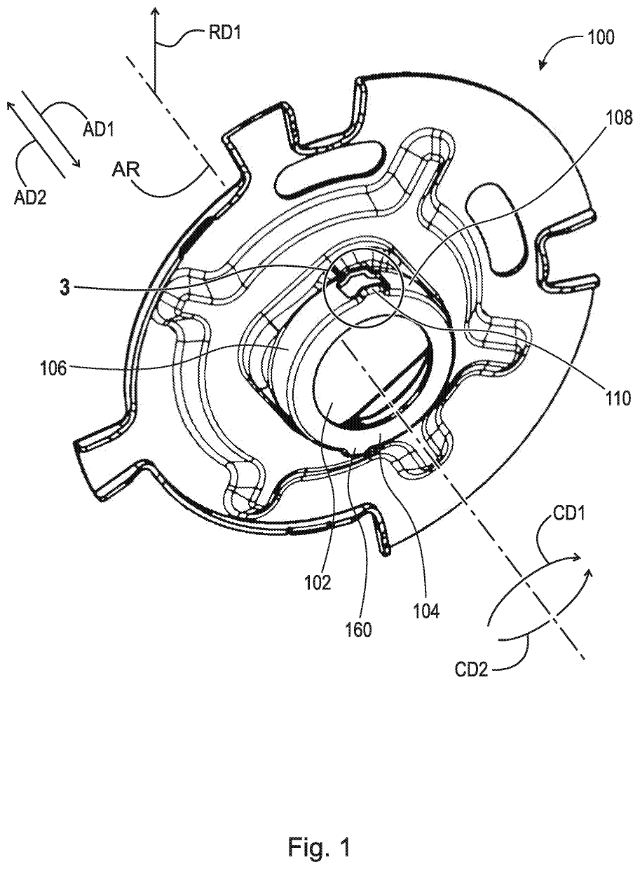

FIG. 1 is a front isometric view of target wheel 100 for a phaser including a heat-treated tab.

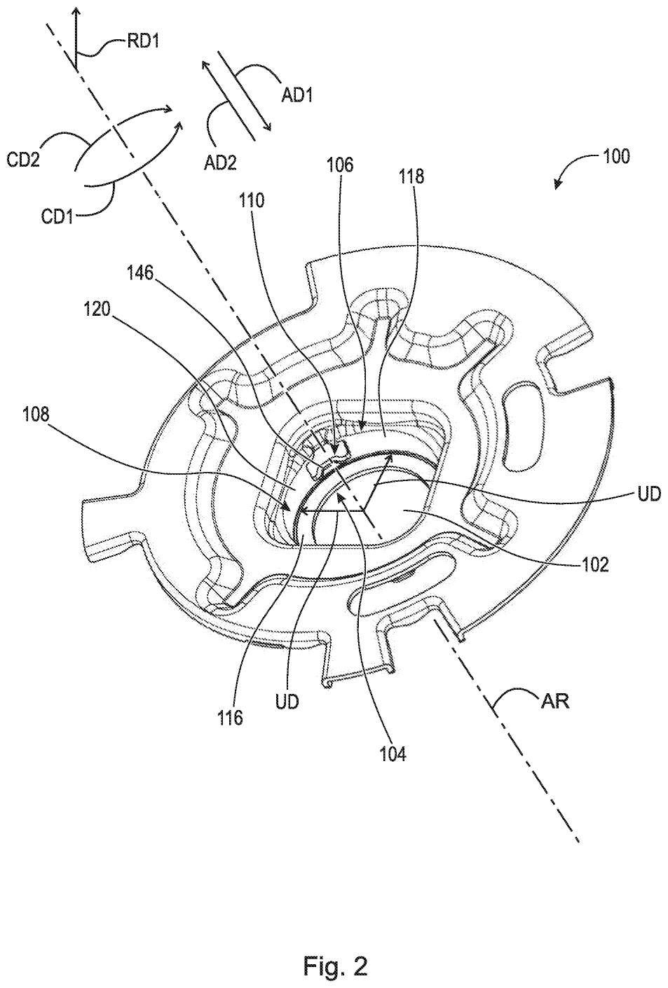

FIG. 2 is a back isometric view of target wheel 100 shown in FIG. 1.

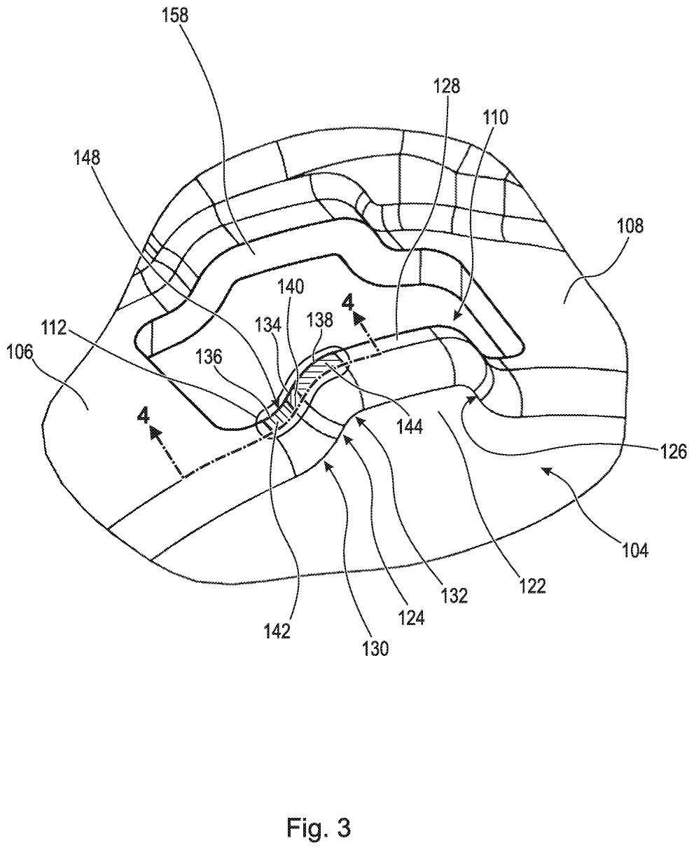

FIG. 3 is a detail of area 3 in FIG. 1. The following should be viewed in light of FIGS. 1 through 3. Target wheel 100 includes: central opening 102; radially disposed wall 104; circumferentially disposed wall 106 connected to wall 104; circumferentially disposed wall 108 connected to wall 104; and tab 110. Axis of rotation AR passes through central opening 102. In the example of FIG. 1, portion 112 of tab 110 is heat-treated. Wall 104: bounds central opening 102; and includes surface 114 facing in axial direction AD1, and surface 116 facing in axial direction AD2, opposite axial direction AD1. Radially inwardly facing surface 118 of wall 106 is at uniform distance UD from axis AR; and, radially inwardly facing surface 120 of wall 108 is at uniform distance UD from axis AR. Stated otherwise, walls 106 and 108 are in the shape of respective portions of a cylinder.

Tab 110 connects wall 106 and 108 and extends past wall 106 and wall 108 in radially outward direction RD1. In an example embodiment, tab 110 includes portion 122 of radially disposed wall 104. Tab 110 includes: side wall 124; wall 126; outer wall 128; linking wall 130; and linking wall 132. Side wall 124 extends radially outwardly and in circumferential direction CD1 with respect to circumferentially disposed wall 106 and includes substantially planar surface 134, facing radially outwardly and in direction CD2, opposite direction CD1. Wall 126 extends radially outwardly and in circumferential direction CD2 from wall 108. Linking wall 130 connects wall 106 and side wall 124 and includes surface 136 facing radially outwardly. Linking wall 132 connects side wall 124 and outer wall 128 and includes surface 138 facing radially outwardly. Wall 126 is connected to outer wall 128.

In an example embodiment, wall 124 and surface 134 include segment 140 of heat-treated portion 112. In an example embodiment, wall 130 and surface 134 include segment 142 of heat-treated portion 112. In an example embodiment, wall 132 and surface 138 include segment 144 of heat-treated portion 112. In an example embodiment (not shown), only one or two of segments 140, 142, and 144 are heat-treated. In an example embodiment (not shown), areas of target wheel 100 greater than portion 112 are heat-treated as described for portion 112. For example, a larger portion of tab 110, all of tab 110, all of tab 110 and a portion of target wheel 100 beyond tab 110, or an entirety of target wheel 100 is heat-treated.

Tab 110 includes radially disposed surface 146 facing in direction AD1. Surface 146 is connected to surfaces 134, 136, and 138 by edge 148. In an example embodiment, segment 140 extends to edge 148. In an example embodiment, segment 142 extends to edge 148. In an example embodiment, segment 144 extends to edge 148.

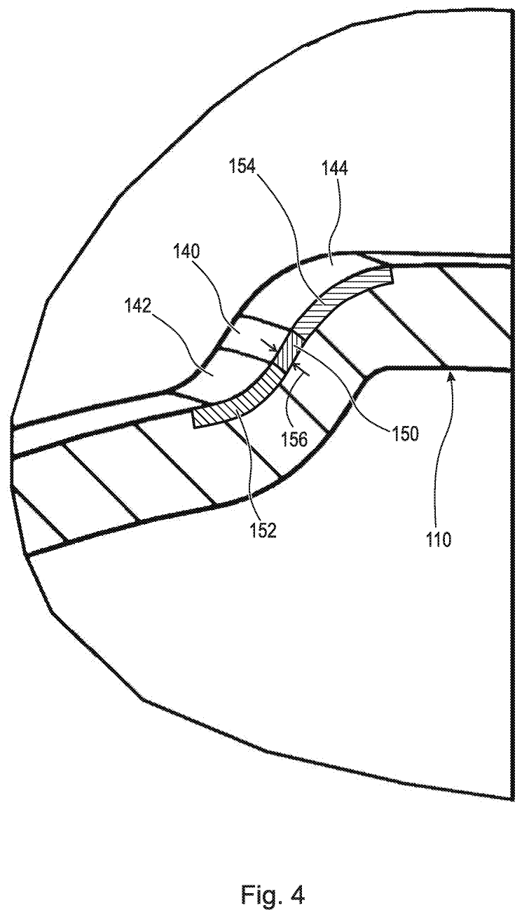

FIG. 4 is a cross-sectional view generally along line 4-4 in FIG. 3. The following should be viewed in light of FIGS. 1 through 4. Portion 112 is heat-treated using a low temperature ferritic nitrocarburizing process. Portion 112 has a surface hardness of at least 500 Knoop Hardness. Heat-treated segments 140, 142, and 144 include surface layers 150, 152, and 154, respectively. In an example embodiment, layers 150, 152, and 154 each have a thickness 156 greater than or equal to 0.005 millimeters and less than or equal to 0.025 millimeter. Thickness 156 is exaggerated in FIG. 4 for purposes of illustration.

In an example embodiment, target wheel 100 includes tab 158. Tab 158: is directly connected to circumferentially disposed wall 106 and circumferentially disposed wall 108; extends radially outward past circumferentially disposed wall 106 and circumferentially disposed wall 108; and is located beyond tab 110 in axial direction AD2.

In an example embodiment, target wheel 100 includes tab 160 extending radially outwardly beyond walls 106 and 108 and connecting walls 106 and 108. The discussion for tab 110 is applicable to tab 160.

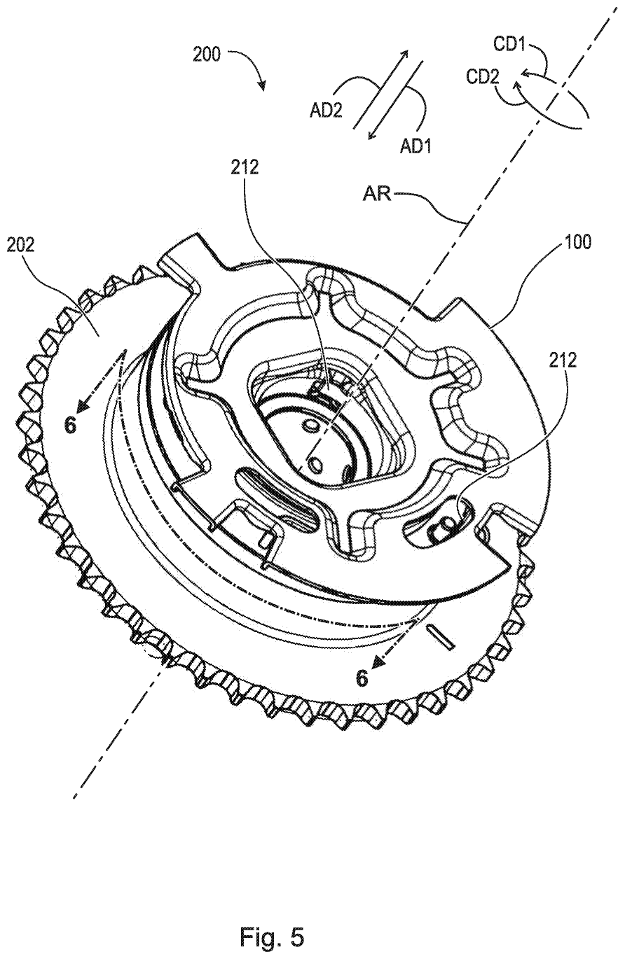

FIG. 5 is back isometric view of camshaft phaser 200 including target wheel 100 shown in FIG. 1.

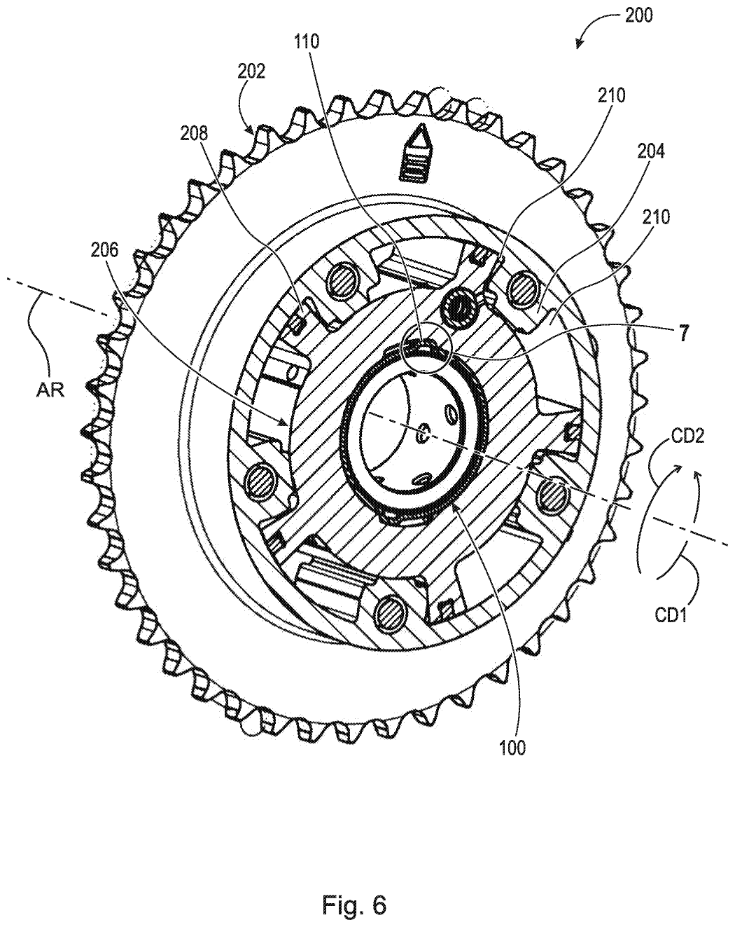

FIG. 6 is a section line generally along line 6-6 in FIG. 5. Camshaft phaser 200 includes: stator 202 arranged to receive rotational torque and including radially inwardly extending protrusions 204; rotor 206 including radially outwardly extending protrusions 208 circumferentially interleaved with radially inwardly extending protrusions 204; phaser chambers 210; bias spring 212 connected to rotor 206; and target wheel 100. Each phaser chamber 210 is circumferentially bounded by: a respective radially inwardly extending protrusion 204; and a respective radially outwardly extending protrusion 208. Tab 110 and tab 158 axially bracket spring 212, grip spring 212, and are fixed to spring 212.

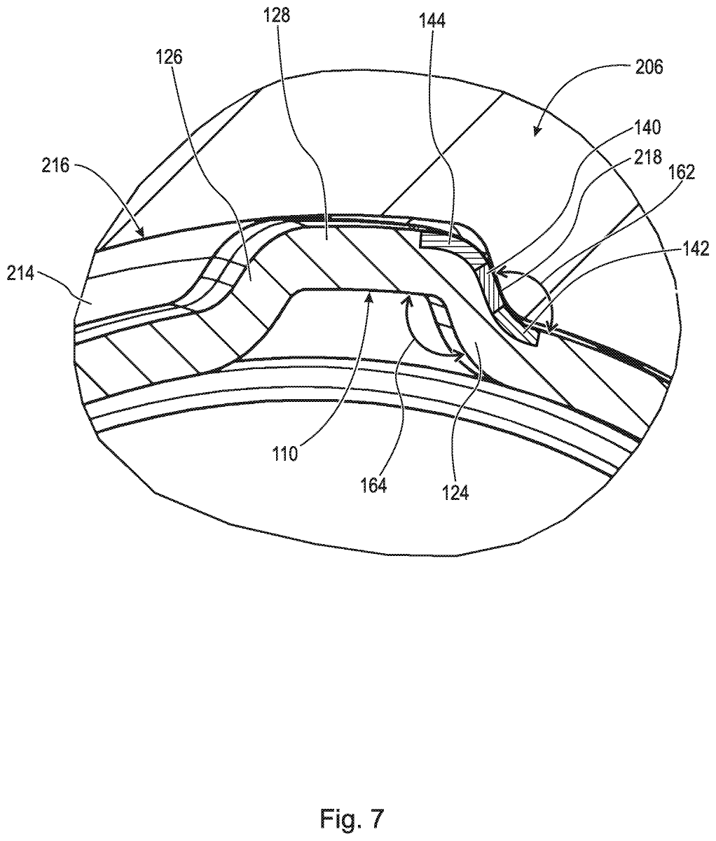

FIG. 7 is a detail of area 7 in FIG. 6. Thickness 156 of surface layers 150, 152, and 154 in FIG. 7 is exaggerated for purposes of illustration. Rotor 206 includes indentation 214 bounded by wall 216 in directions RD1, CD1, and CD2. Portion 218 of wall 216 bounds indentation 214 in direction CD2. Tab 110 is disposed in indentation 214 and bias spring 212 urges tab 110 in direction CD2 and into contact with portion 218 of wall 216, resulting in contact between portion 218 and some or all of heat-treated segments 140, 142, and 144.

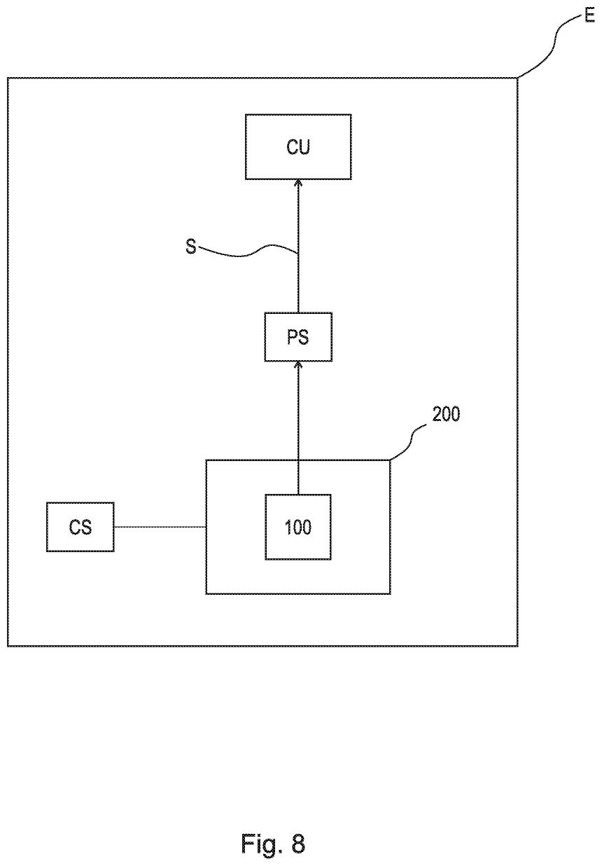

FIG. 8 is a schematic block diagram including camshaft phaser 200 shown in FIG. 5. As is known in the art, target wheel 100 is arranged to interface with position sensor PS to detect a rotational, or circumferential, position of target wheel 100, and through the rotational position of target wheel 100, respective rotational, or circumferential positions of rotor 206 and camshaft CS, non-rotatably connected to rotor 206. For example, sensor PS sends signal S, including the rotational, or circumferential, position of target wheel 100, to control unit CU for engine E including camshaft phaser CS. Control unit CU uses signal S and other data to control phasing of camshaft CS.

The following should be viewed in light of FIGS. 1 through 8. The following describes a method of fabricating a target wheel for a camshaft phaser. Although the method is presented as a sequence of steps for clarity, no order should be inferred from the sequence unless explicitly stated. A first step forms the target wheel to include: a first circumferentially disposed wall; a second circumferentially disposed wall; a tab arranged to engage a rotor for a camshaft phaser, directly connected to the first circumferentially disposed wall and the second circumferentially disposed wall, and extending radially outward past the first circumferentially disposed wall and the second circumferentially disposed wall. A second step heat-treats a portion of the tab, all of the tab, the tab and a portion of the target wheel beyond the tab, or all of the target wheel.

In an example embodiment, heat-treating the portion of the tab includes heat-treating the portion of the tab using a low temperature ferritic nitrocarburizing process. In an example embodiment, heat-treating the portion of the tab includes: heat-treating the portion of the tab to a surface hardness of at least 500 Knoop Hardness; or heat-treating a surface layer of the tab, with a thickness greater than or equal to 0.005 millimeters and less than or equal to 0.025 millimeter, to a surface hardness of at least 500 Knoop Hardness.

In an example embodiment: forming the target wheel to include the tab includes forming a side wall extending radially outwardly and in a first circumferential direction with respect to the first circumferentially disposed wall, forming a wall extending radially outwardly and in a second circumferential direction from the second circumferentially disposed wall, forming an outer wall connected to the wall, forming a first linking wall connecting first circumferentially disposed wall and the side wall, and forming a second linking wall connecting the side wall and the outer wall; and heating treating the portion of the tab includes heat-treating a portion of one or more of the side wall, the first linking wall, or the second linking wall.

During assembly of camshaft phaser 200, spring 212 rotates target wheel 100 with respect to rotor 206 such that tab 110 contacts rotor 206. Further, rough handling prior to installation of spring 212 can cause contact between tab 110 and rotor 206. However, heat-treated portion 112 of tab 110, which would typically contact rotor 206, is strengthened due to the heat-treating process, which greatly reduces or eliminates possible damage to tab 110 and possible mis-alignment of target wheel 100 with respect to rotor 206 and camshaft CS. For example, portion 112 resists bending so that: angle 162 between walls 106 and 124 is maintained; and angle 164 between walls 124 and 128 is maintained. Thus, sensor PS properly reads the rotational positions of target wheel 100, rotor 206, and camshaft CS, ensuring proper phasing of camshaft CS. Heat-treating portion 112 also increases the durability and service life of target wheel 100. Further, the increased strength of heat-treated portion 112 enables the fabrication of target wheel 100 using thinner sheet steel in a stamping process, reducing production costs as well as reducing inertia due to target wheel 100.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE CHARACTERS

AD1 axial direction
AD2 axial direction
AR axis of rotation
CD1 circumferential direction
CD2 circumferential direction
RD1 radially outward direction
UD uniform distance
100 target wheel
102 central opening
104 radially disposed wall
106 circumferentially disposed wall
108 circumferentially disposed wall
110 tab
112 heat-treated portion, tab
114 surface, wall 104
116 surface, wall 104
118 surface, wall 106
120 surface, wall 108
122 portion, wall 104
124 side wall, tab
126 wall, tab
128 outer wall, tab
130 linking wall, tab
132 linking wall, tab
134 planar surface, wall 124
136 surface, wall 130
138 surface, wall 132
140 segment, portion 112
142 segment, portion 112
144 segment, portion 112
146 surface, tab
148 edge, tab
150 surface layer, segment 140
152 surface layer, segment 142
154 surface layer, segment 144
156 thickness, surface layer
158 tab
160 tab
162 angle
164 angle
200 camshaft phases
202 stator
204 protrusion, stator
206 rotor
208 protrusion, rotor
210 phase chamber
212 bias spring
214 indentation, rotor
216 wall, indentation
218 portion, wall 216

1. A target wheel for a camshaft phaser, comprising:
a radially disposed wall facing in a first axial direction;
a first circumferentially disposed wall connected to the radially disposed wall;
a second circumferentially disposed wall connected to the radially disposed wall; and,
a first tab:
directly connected to the first circumferentially disposed wall and the second circumferentially disposed wall;
extending radially outward past the first circumferentially disposed wall and the second circumferentially disposed wall; and,
including a heat-treated portion.

2. The target wheel of claim 1, wherein the first tab includes a portion of the radially disposed wall.

3. The target wheel of claim 1, wherein:
the first tab includes a side wall extending radially outwardly and in a first circumferential direction with respect to the first circumferentially disposed wall; and,
the side wall includes a segment of the heat-treated portion.

4. The target wheel of claim 1, wherein:
the first tab includes a side wall extending radially outwardly and in a first circumferential direction with respect to the first circumferentially disposed wall;
the side wall includes a surface facing radially outwardly and in a second circumferential direction, opposite the first circumferential direction; and,
the surface includes a segment of the heat-treated portion.

5. The target wheel of claim 1, wherein:
the first tab includes:
a side wall extending radially outwardly and in a first circumferential direction with respect to the first circumferentially disposed wall;
a surface facing in a second axial direction, opposite the first axial direction; and,
an edge connecting the side wall and the surface;
the side wall includes at least a segment of the heat-treated portion; and,
the heat-treated portion includes a segment of the edge.

6. The target wheel of claim 1, wherein:
the first tab includes:
a side wall extending radially outwardly and in a first circumferential direction with respect to the first circumferentially disposed wall; and,
a linking wall connecting the first circumferentially disposed wall and the side wall; and,
the linking wall includes a segment of the heat-treated portion.

7. The target wheel of claim 1, wherein:
the first tab includes:
a side wall extending radially outwardly and in a first circumferential direction with respect to the first circumferentially disposed wall; and,
a linking wall connecting the first circumferentially disposed wall and the side wall;
the linking wall includes a surface facing radially outwardly; and,
the surface includes a segment of the heat-treated portion.

8. The target wheel of claim 1, wherein:
the first tab includes:
a side wall extending radially outwardly and in a first circumferential direction with respect to the first circumferentially disposed wall;
a wall extending radially outwardly and in a second circumferential direction, opposite the first circumferential direction, from the second circumferentially disposed wall;
an outer wall connected to the wall; and,
a linking wall connecting the side wall and the outer wall; and,
the linking wall includes a segment of the heat-treated portion.

9. The target wheel of claim 1, wherein:
the first tab includes:
a side wall extending radially outwardly and in a first circumferential direction with respect to the first circumferentially disposed wall;
a wall extending radially outwardly and in a second circumferential direction, opposite the first circumferential direction, from the second circumferentially disposed wall;
an outer wall connected to the wall; and,
a linking wall connecting the side wall and the outer wall;
the linking wall includes a surface facing radially outwardly; and,
the surface includes a segment of the heat-treated portion.

10. The target wheel of claim 1, wherein the heat-treated portion of the first tab has a surface hardness of at least 500 Knoop Hardness.

11. The target wheel of claim 1, wherein:
the heat-treated portion of the first tab includes a surface layer with a thickness greater than or equal to 0.005 millimeters and less than or equal to 0.025 millimeter; and,
the surface layer has a surface hardness of at least 500 Knoop Hardness.

12. The target wheel of claim 1, further comprising:
a second tab:
directly connected to the first circumferentially disposed wall and to the second circumferentially disposed wall;
extending radially outward past the first circumferentially disposed wall and the second circumferentially disposed wall; and,
located beyond the first tab in a second axial direction, opposite the first axial direction.

13. The target wheel of claim 12, wherein:
the target wheel is arranged to be installed in a camshaft phaser;
the first tab and the second tab are arranged to grip a bias spring of the camshaft phaser;
the heat-treated portion is arranged to be rotated by the bias spring into contact with a rotor of the camshaft phaser; and,
a sensor is arranged to detect a rotational position of the target wheel for use in rotating the rotor, with respect to a stator of the camshaft phaser, to change a phase of a camshaft connected to the rotor.

14. A camshaft phaser, comprising:
a stator arranged to receive rotational torque and including a plurality of radially inwardly extending protrusions;
a rotor including:
a plurality of radially outwardly extending protrusions circumferentially interleaved with the plurality of radially inwardly extending protrusions; and,
an indentation bounded by a wall;
a plurality of phaser chambers, each phaser chamber circumferentially bounded by:
a respective radially inwardly extending protrusion included in the plurality of radially inwardly extending protrusions; and,
a respective radially outwardly extending protrusion included in the plurality of radially outwardly extending protrusions;
a target wheel including a tab with a heat-treated portion; and,
a bias spring urging:
the target wheel in a first circumferential direction; and,
the heat-treated portion into contact with the wall of the rotor, wherein a sensor is arranged to detect a rotational position of the target wheel for use in rotating the rotor, with respect to the stator, to change a phase of a camshaft connected to the rotor.

15. The camshaft phaser of claim 14, wherein:
the tab:
is disposed in the indentation;
is fixed to the bias spring; and,
includes a side wall with a surface facing radially outwardly and in a second circumferential direction, opposite the first circumferential direction; and,
the surface includes a segment of the heat-treated portion.

16. The target wheel of claim 14, wherein:
the heat-treated portion of the tab has a surface hardness of at least 500 Knoop Hardness; or,
the heat-treated portion of the tab includes a surface layer with a thickness greater than or equal to 0.005 millimeters and less than or equal to 0.025 millimeter, and the surface layer has a surface hardness of at least 500 Knoop Hardness.

17. A method of fabricating a target wheel for a camshaft phases, comprising:
forming the target wheel to include:
a radially disposed wall facing in an axial direction;
a first circumferentially disposed wall connected to the radially disposed wall;
a second circumferentially disposed wall connected to the radially disposed wall; and,
a tab:
arranged to engage a rotor for a camshaft phaser;
directly connected to the first circumferentially disposed wall and the second circumferentially disposed wall; and,
extending radially outward past the first circumferentially disposed wall and the second circumferentially disposed wall; and,
heat-treating a portion of the tab.

18. The method of claim 17 wherein heat-treating the portion of the tab includes heat-treating the portion of the tab using a low temperature ferritic nitrocarburizing process.

19. The method of claim 18 wherein heat-treating the portion of the tab includes:
heat-treating the portion of the tab to a surface hardness of at least 500 Knoop Hardness; or,
heat-treating a surface layer of the tab, with a thickness greater than or equal to 0.005 millimeters and less than or equal to 0.025 millimeter, to a surface hardness of at least 500 Knoop Hardness.

20. The method of claim 17 wherein:
forming the target wheel to include the tab includes:
forming a side wall extending radially outwardly and in a first circumferential direction with respect to the first circumferentially disposed wall;
forming a wall extending radially outwardly and in a second circumferential direction, opposite the first circumferential direction, from the second circumferentially disposed wall;
forming an outer wall connected to the wall;
forming a first linking wall connecting first circumferentially disposed wall and the side wall; and,
forming a second linking wall connecting the side wall and the outer wall; and,
heating treating the portion of the tab includes heat-treating a portion of one or more of the side wall, the first linking wall, or the second linking wall.
